(19) United States
(12) Patent Application Publication
(10) Pub. No.: US 2019/0118343 A1
(43) Pub. Date: Apr. 25, 2019

(54) DEVICE FOR MANIPULATING A SICKLE STONE

(71) Applicant: Gerard John Aucoin, Lexington, MA (US)

(72) Inventor: Gerard John Aucoin, Lexington, MA (US)

(21) Appl. No.: 16/167,862

(22) Filed: Oct. 23, 2018

Related U.S. Application Data
(60) Provisional application No. 62/576,429, filed on Oct. 24, 2017.

(51) Int. Cl. B24D 15/02; B25G 3/26

(52) U.S. Cl. CPC B24D 15/02; B25G 3/26

(57) ABSTRACT

A masonry device is provided. The masonry device is dimensioned and adapted to operatively associate with a sickle stone so that a mason may utilize sickle stone through a handle portion of the masonry device. The masonry device may include a sleeve defining a saddle void for receiving the sickle stone. A locking mechanism is provided for removably securing the sickle stone in the saddle void during use. As a result, a user of the masonry device may manipulate the sickle stone without directly handling it, as well as use sickle stone to its last inch.

### CROSS-REFERENCE TO RELATED APPLICATION

This application claims the benefit of priority of U.S. provisional application No. 62/576,429, filed 24 Oct. 2017, the contents of which are herein incorporated by reference.

### BACKGROUND OF THE INVENTION

The present invention relates to masonry tools and, more particularly, to a device for safely and advantageously manipulating a sickle stone.

Masons use sickle stones to remove excess concrete/debris from the finished masonry product after applying an acidic solution or chemicals thereto (usually by a brush). Currently this approach has at least two problems: the first problem is exposure to the acidic solution of the chemicals that come in contact with the sickle stones and thus may be transferred to the user of the sickle stone, particularly exposure to the hand of the mason that is manipulating the sickle stone; and second problem is waste, when the sickle stone gets smaller as it is used, and the shorter the sickle stone, the more difficult for the mason to utilize and so shorter sickle stones are discard prior to being fully utilized.

As can be seen, there is a need for a device for manipulating a sickle stone. The device embodied in the present invention allows masons to keep their hands safely away from acid solution and allow the last inches of the sickle stone to be used, rather than typically discarding the sickle stone when it is still up to four inches in length. Thereby, the present invention increases occupational safety within the masonry field, while preventing waste and saving money.

### SUMMARY OF THE INVENTION

In one aspect of the present invention, a masonry device for manipulating a sickle stone includes the following: a sleeve having a length extending from an opening end to a handle end; a saddle void defined by the sleeve; a saddle opening communicating the opening end and the saddle void, the saddle void and saddle opening dimensioned to slidably receive a sickle stone; a handle portion joined to the sleeve; and a fastener hole communicating to the saddle void, the fastener hole dispose on the sleeve adjacent to the opening end.

In another aspect of the present invention, the masonry device for manipulating a sickle stone includes the following: a sleeve having a length extending from an opening end to a handle end; a saddle void defined by the sleeve; a saddle opening communicating the opening end and the saddle void, the saddle void and saddle opening dimensioned to slidably receive a sickle stone; a handle portion coaxially joined to the sleeve; and a threaded fastener hole communicating to the saddle void, the fastener hole dispose on the sleeve adjacent to the opening end, wherein the threaded fastener hole is one-half to one and one-half inches from the opening end; and a threaded fastener adapted to operatively associate with the threaded fastener hole so as to extend through the sleeve and into the saddle void for removably securing the sickle stone therein.

In yet another aspect of the present invention, method for safely and cost effectively utilizing a sickle stone includes the following steps of: providing the above-mentioned masonry device; sliding a sickle stone into the saddle void; and tightening the threaded fastener until the sickle stone is secured within the saddle void.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, operatively associated with a sickle stone;

FIG. 2 is a perspective view of an exemplary embodiment of the present invention;

FIG. 3 is an exploded perspective view of an exemplary embodiment of the present invention; and

FIG. 4 is a sectional view of an exemplary embodiment of the present invention, taken along line 4-4 in FIG. 1, and shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a masonry device dimensioned and adapted to operatively associate with a sickle stone so that a mason may utilize sickle stone through a handle portion of the masonry device. The masonry device may include a sleeve defining a saddle void for receiving the sickle stone. A locking mechanism is provided for removably securing the sickle stone in the saddle void during use. As a result, a user of the masonry device may manipulate the sickle stone without directly handling it, as well as use sickle stone to its last inch.

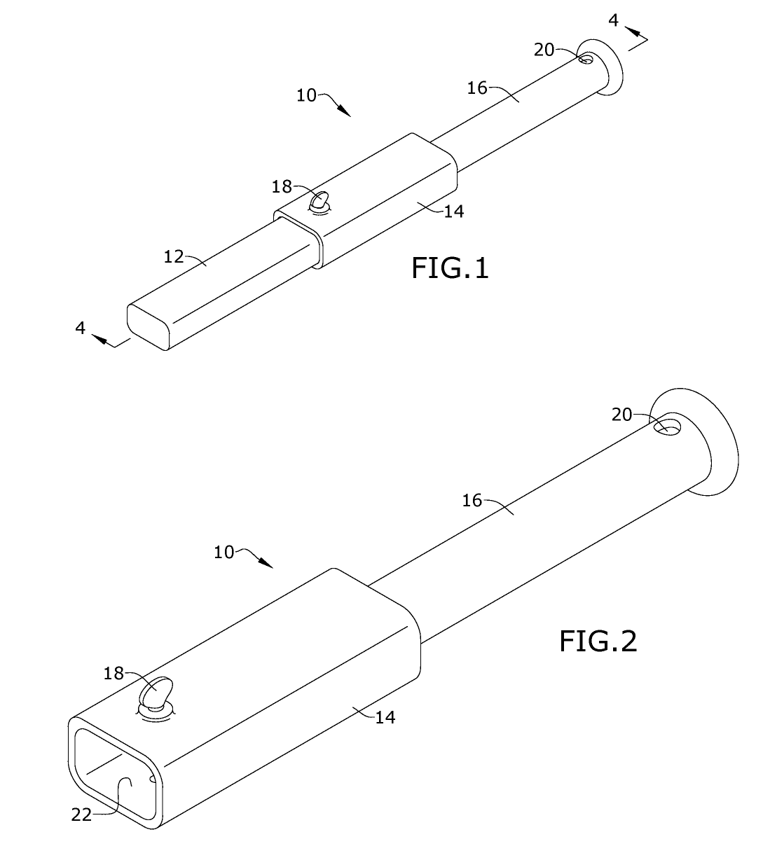

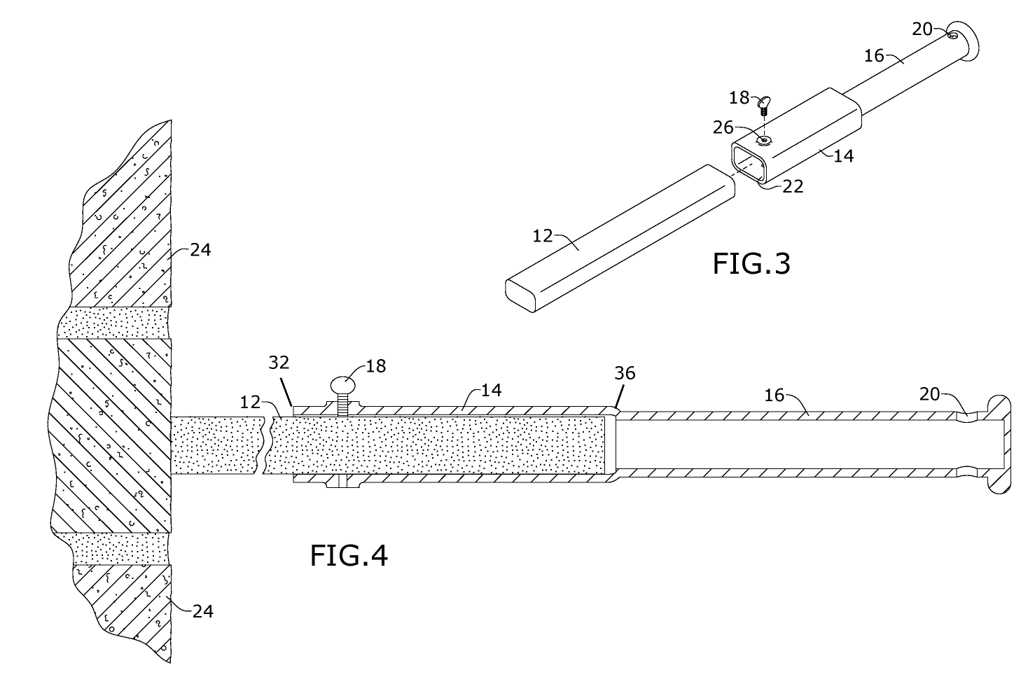

Referring to Figures. 1 through 4, the present invention may include a masonry device 10 for manipulating a sickle stone 12. The masonry device 10 provides a sleeve 12 and a handle 16 extending therefrom. In certain embodiments, such as the ones illustrated in the Figures, the handle 16 extend coaxially from the sleeve 12. It is to be understood, though, that the present invention embodies the handle 16 extending transversely from the sleeve 12, possibly midpoint there along.

The sleeve 14 may have a length extending from an opening end 32 to a handle end 36. The opening end 32 provides an opening communicating to a void or saddle (“saddle void”) 22 defined by the sleeve 14 for accommodating the sickle stone 12. The opening and saddle void 22 may be dimensioned and adapted for slidably receiving the sickle stone 12, as best illustrated in FIG. 4, so as to provide approximately 5 percent or less tolerance or difference between the cross-sectional area of the saddle void 22 and the cross-sectional area of the sickle stone 12. The saddle void 22 may extend the substantial length of the sleeve 14 but need not to.

Inward yet adjacent to the opening end 32, approximately one inch or less therefrom, a threaded hole 26 may be provided along a surface of the sleeve 14 so that the threaded hole communicates to the saddle void 22. A threaded fastener 18 may be dimensioned and adapted to operatively engage the threaded hole 26 so that the threaded fastener 18 may also communicate to the saddle void 22. If a sickle stone 12 is present in the saddle void 22 adjacent to the threaded hole 26 the threaded fastener 18 would lockingly engage the sickle stone 12, urging the sickle stone 12 securely against an opposing inner surface of the sleeve 14, as illustrated in FIG. 4, and/or providing frictional or clamping engagement to the sickle stone 12. The threaded fastener 18 may be a thumb screw, hose clamp or the like.

At or adjacent to a distal end of the handle 16 a hanging opening 20 may be provided so that a lanyard (not shown) or the like may be engaged therein so that a user may secure the masonry device 10 to, say, their wrist, thereby preventing unintentionally dropping or losing the masonry device 10.

The sleeve 14 may extend for a distance ranging from eight to sixteen inches or longer or shorter so long as the masonry device 10 functions as disclosed herein. The handle 16 may be have a length sufficient to manipulate the masonry device 10 at least one-handed. The material of the sleeve 14 and the handle 16 may be sufficiently strong and resistant to bending, such material may be wood, rubber and/or various plasticized materials.

A method of using the present invention may include the following. The masonry device 10 disclosed above may be provided. A user would slide the sickle stone 12 into the saddle void 22 enough so that the threaded fastener may lockingly, securely engage a portion of the sickle stone 12. Then the user would manipulate the handle 16 of the masonry device 10 to clean masonry surfaces 24 with the sickle stone 12 when using acid solution applied to the masonry surfaces 24. The masonry device 10 allows the user to safely keep their hands away from the acid solution, while using a greater portion of the sickle stone 12, thereby preventing waste. Furthermore, the masonry device 10 allows the mason additional leverage during the application of the sickle stone 12.

Also, the present invention can be used for tool and knife sharpening.

It should be understood, of course, that the foregoing relates to exemplary embodiments of the invention and that modifications may be made without departing from the spirit and scope of the invention as set forth in the following claims.

What is claimed is:

1. A device for manipulating a sickle stone, comprising:
a sleeve having a length extending from an opening end to a handle end;
a saddle void defined by the sleeve;
a saddle opening communicating the opening end and the saddle void,
the saddle void and saddle opening dimensioned to slidably receive a sickle stone;
a handle portion joined to the sleeve; and
a fastener hole communicating to the saddle void, the fastener hole dispose on the sleeve adjacent to the opening end.

2. The masonry device of claim 1, further comprising a fastener adapted to operatively associate with the fastener hole so as to extend through the sleeve and into the saddle void for removably securing the sickle stone therein.

3. The masonry device of claim 2, wherein the fastener hole and the fastener are threaded to operatively associate with each other.

4. The masonry device of claim 1, wherein the handle portion is coaxially joined to the sleeve.

5. The masonry device of claim 1, wherein the fastener hole is one-half to one and one-half inches from the opening end.

6. The masonry device of claim 1, further comprising a hanging hole disposed along a distal end of the handle portion.

7. The masonry device of claim 1, wherein a cross-sectional difference in surface area of the saddle void relative to the sickle stone is five percent or less.

8. A device for manipulating a sickle stone, comprising:
a sleeve having a length extending from an opening end to a handle end;
a saddle void defined by the sleeve;
a saddle opening communicating the opening end and the saddle void,
the saddle void and saddle opening dimensioned to slidably receive a sickle stone;
a handle portion coaxially joined to the sleeve; and
a threaded fastener hole communicating to the saddle void, the fastener hole dispose on the sleeve adjacent to the opening end, wherein the threaded fastener hole is one-half to one and one-half inches from the opening end; and
a threaded fastener adapted to operatively associate with the threaded fastener hole so as to extend through the sleeve and into the saddle void for removably securing the sickle stone therein.

9. The masonry device of claim 7, further comprising a hanging hole disposed along a distal end of the handle portion.

10. The masonry device of claim 7, wherein a cross-sectional difference in surface area of the saddle void relative to the sickle stone is five percent or less.

11. A method for safely and cost effectively utilizing a sickle stone, comprising the steps of:
providing the masonry device of claim 8;
sliding a sickle stone into the saddle void; and
tightening the threaded fastener until the sickle stone is secured within the saddle void.
